(19) United States
(12) Patent Application Publication
(10) Pub. No.: US 2026/0317509 A1
(43) Pub. Date: Oct. 15, 2026

(54) MAGNETIC MATERIAL COMPRISING FERRITE PELLETS, A METHOD FOR MANUFACTURING THE SAME, AND A WIRELESS CHARGING DEVICE COMPRISING THE SAME

(71) Applicants: HYUNDAI MOTOR COMPANY, Seoul (KR); KIA CORPORATION, Seoul (KR)

(72) Inventors: Youngmin Kim, Hwaseong-si (KR); Dohyeon Lee, Wonju-si (KR); Bumgyun Shin, Wonju-si (KR); Jangwook Lee, Wonju-si (KR)

(73) Assignees: HYUNDAI MOTOR COMPANY, Seoul (KR); KIA CORPORATION, Seoul (KR)

(21) Appl. No.: 19/294,093

(22) Filed: Aug. 7, 2025

(30) Foreign Application Priority Data
Apr. 10, 2025 (KR) 10-2025-0046508

(51) Int. Cl. C08K 3/22; C08K 7/18; H01F 1/047

(52) U.S. Cl. CPC C08K 3/22; C08K 7/18; H01F 1/047; C08K 2003/2296; C08K 2201/003; C08K 2201/005; C08K 2201/01

(57) ABSTRACT

A magnetic material including MnZn ferrite pellets and MnZn ferrite powder is provided. The magnetic material includes a range of 65 to 95 parts by weight of manganese zinc (MnZn) ferrite pellets and a range of 10 to 25 parts by weight of a MnZn ferrite powder. A wireless charging device including the magnetic material is provided. Further a method of manufacturing a magnetic material is provided. The method includes synthesizing manganese zinc (MnZn) ferrite pellets and mixing the MnZn ferrite pellets with a MnZn ferrite powder. Synthesizing the MnZn ferrite pellets includes mixing pellet raw materials, calcining the mixed pellet raw materials, pulverizing the calcined pellet raw materials, and granulating the pulverized pellet raw materials.

### CROSS REFERENCE TO RELATED APPLICATION

This present application claims priority to Korean Patent Application No. 10-2025-0046508, filed on Apr. 10, 2025, in the Korean Intellectual Property Office, the entire disclosure of which is incorporated herein by reference.

### FIELD

The present disclosure relates to a magnetic material comprising manganese zinc (MnZn) ferrite pellets and MnZn ferrite powder, a method for manufacturing the same, and a wireless charging device comprising the same.

### BACKGROUND

With the increasing distribution of electric vehicles, there has been growing interest in wireless charging technology that enables battery charging without wired chargers. Wireless charging technology consists of a transmitter that transmits power and a receiver that receives the transmitted power, and these transmitter and receiver components are composed of coils and magnetic materials. The magnetic material used therein is one of the key components determining wireless charging efficiency and is provided in the wireless charging device in the form of a pad. While ferrite tiles have been primarily used for such magnetic pads, ferrite tile magnetic materials are vulnerable to impact due to the high brittleness characteristics of ceramic tiles and are difficult to manufacture in three-dimensional shapes. In particular, for the receiving part (vehicle) of an electric vehicle wireless charging system, there is a disadvantage that the ferrite tile magnetic material can be easily damaged by vibration and external impact during driving. To overcome these disadvantages, efforts have been continuously made to develop ferrite magnetic materials that are resistant to external impact while also exhibiting excellent magnetic properties.

The matters described in this Background section are only for enhancement of understanding of the background of the disclosure, and should not be taken as acknowledgement that they correspond to prior art already known to those having ordinary skill in the art.

### SUMMARY

The following summary presents a simplified summary of certain features. The summary is not an extensive overview and is not intended to identify key or critical elements.

The present disclosure is directed to providing a magnetic material comprising manganese zinc (MnZn) ferrite pellets and MnZn ferrite powder having improved magnetic characteristics and strength characteristics, a method for manufacturing the same, and a wireless charging device comprising the same.

A magnetic material according to an embodiment of the present disclosure may comprise a range of 65 to 95 parts by weight of MnZn ferrite pellets and a range of 10 to 25 parts by weight of MnZn ferrite powder.

A wireless charging device according to an embodiment of the present disclosure may comprise the magnetic material according to various embodiments of the present disclosure.

A method for manufacturing a magnetic material according to an embodiment of the present disclosure may comprise synthesizing MnZn ferrite pellets and mixing the MnZn ferrite pellets with MnZn ferrite powder.

Synthesizing the MnZn ferrite pellets may comprise mixing pellet raw materials, calcining the mixed pellet raw materials, pulverizing the calcined pellet raw materials, and granulating the pulverized pellet raw materials.

The magnetic material according to embodiments of the present disclosure may exhibit improved permeability and magnetic characteristics by including not only MnZn ferrite powder but also MnZn ferrite pellets.

Furthermore, the magnetic material may be resistant to external impact.

The magnetic material according to embodiments of the present disclosure may be manufactured by low-pressure hot forming, enabling an increase in the cross-sectional area of the magnetic material. Accordingly, the magnetic material may be manufactured with a large area that is more than nine times the size of existing ferrite magnetic materials.

The magnetic material according to embodiments of the present disclosure may be manufactured with a forming pressure that is more than 80% lower than that of existing ferrite tiles, thereby enabling improved process efficiency.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a graph showing tap density measurement results of pellets according to Experimental Example 1.

FIG. 2 is a graph showing permeability measurement results of the magnetic material according to Experimental Example 1.

### DETAILED DESCRIPTION

Unless otherwise defined, all terms (including technical and scientific terms) used herein as is customary in the art to which the inventive concept of the present disclosure belongs. It should be further understood that terms in common usage should also be interpreted as is customary in the relevant art and not in an idealized or overly formal sense unless expressly so defined herein.

Although the terms “first,” “second,” and other numerical terms may be used herein to describe various elements, these elements should not be limited by these terms. These terms are only used to distinguish one element from another. For example, a first element could be termed a second element, and, similarly, a second element could be termed a first element, without departing from the scope of the present disclosure.

The terminology used herein is used for the purpose of describing particular embodiments only and is not intended to be limiting. As used herein, the articles “a,” “an,” and “the,” include plural referents unless the context clearly dictates otherwise. In the following disclosure, the terms “include,” “comprise,” “have,” and the like designate the existence of features, steps, elements, and combinations thereof, but should not be understood as precluding the existence or addition of one or more other features, steps, elements, and combinations thereof.

A magnetic material according to embodiments of the present disclosure may comprise manganese zinc (MnZn) ferrite pellets and MnZn ferrite powder.

The magnetic material of the present disclosure may comprise a range of 65 to 95 parts by weight of the MnZn ferrite pellets. If the pellets are included in less than 65 parts by weight, the magnetic characteristics of the magnetic material may deteriorate. If the pellets are included in more than 95 parts by weight, the formability of the magnetic material may deteriorate. Therefore, the above range may be advantageous. The MnZn ferrite pellets may have a millimeter-scale size and may be prepared by pulverizing pellet raw materials and subsequently granulating the pulverized material. The MnZn ferrite pellets may improve the permeability of the magnetic material.

In one example, the MnZn ferrite pellets may be spherical MnZn ferrite pellets having a diameter in a range of 2 mm to 5 mm. If the diameter of the pellets is less than 2 mm, the magnetic characteristics of the magnetic material may deteriorate. If the diameter of the pellets exceeds 5 mm, it may be impossible to implement the thickness of the magnetic material. Therefore, the above range may be advantageous.

The method for manufacturing such pellets and a detailed description thereof are provided below.

The magnetic material of the present disclosure may comprise a range of 10 to 25 parts by weight of the MnZn ferrite powder. If the powder is included in less than 10 parts by weight, the formability of the magnetic material may deteriorate. If the powder is included in more than 25 parts by weight, the magnetic characteristics of the magnetic material may deteriorate. Therefore, the above range may be advantageous.

According to an embodiment of the present disclosure, the MnZn ferrite powder may have a diameter in a range of 35 to 90 μm. The powder may be obtained by removing impurities through a calcination process from a mixture including iron oxide, manganese oxide, and zinc oxide to produce a synthetic phase, followed by pulverization and drying.

According to an embodiment of the present disclosure, the MnZn ferrite powder may further comprise MnZn ferrite fine particles. The fine particles may refer to particles that are smaller in size than the MnZn ferrite powder.

In one example, the fine particles may have a diameter in a range of 4 to 15 km. The fine particles may be produced by further pulverizing the MnZn ferrite powder.

In one example, the MnZn ferrite fine particles and the MnZn ferrite powder may be included in a weight ratio in a range of 0:10 to 6:4. The magnetic material according to an embodiment of the present disclosure may implement various densities and other required physical properties by including both MnZn ferrite powder and smaller-sized MnZn ferrite fine particles.

The magnetic material according to the present disclosure may further comprise a binder. The binder may be a liquid silicone binder. In one example, the binder may be included in a range of 2.5 to 6 parts by weight. The magnetic material of the present disclosure may exhibit excellent magnetic characteristics and strength characteristics by including a liquid binder. These effects are described in detail through Experimental Examples below.

The magnetic material of the present disclosure described above may be in the form of a pad.

A wireless charging device of the present disclosure may comprise the magnetic material according to various embodiments of the present disclosure described above. In one example, the wireless charging device may be a wireless charging device for electric vehicles.

A method for manufacturing a magnetic material according to the present disclosure is described below.

The method for manufacturing a magnetic material according to the present disclosure may comprise synthesizing MnZn ferrite pellets and mixing the MnZn ferrite pellets with MnZn ferrite powder.

In the synthesizing the MnZn ferrite pellets may comprise mixing pellet raw materials, calcining the mixed pellet raw materials, pulverizing the calcined pellet raw materials, and granulating the pulverized pellet raw materials.

In the mixing the pellet raw materials, the pellet raw materials may comprise iron oxide, manganese oxide, and zinc oxide. In one example, the pellet raw materials may comprise a range of 65 to 75 parts by weight of iron oxide, a range of 15 to 30 parts by weight of manganese oxide, and a range of 5 to 15 parts by weight of zinc oxide.

The calcining the mixed pellet raw materials may be carried out in a range of 800 to 1000° C. Through the calcining, the present disclosure may improve the sinterability and uniformity of the pellet raw materials, and remove volatile impurities that would otherwise be generated in a firing process to be described below.

The pulverizing the calcined pellet raw materials may be carried out through wet pulverization. Through the wet pulverization, the pellet raw materials may be pulverized to a particle size of about 1 μm or less.

According to an embodiment of the present disclosure, after the pulverizing the calcined pellet raw materials, the method may further comprise adding an additive. The additive may comprise CaO, Nb₂O₃, Co₃O₄, ZrO₂, SnO₂, Ta₂O₅, V₂O₅, or any combination thereof. The present disclosure may improve magnetic characteristics through the use of such additives.

According to an embodiment of the present disclosure, after the adding the additive, the method may further comprise spray-drying the pellet raw materials. In other words, after adding the additive to the pulverized pellet raw materials as described above, the materials may be sprayed using a sprayer and dried by contacting high-temperature air. The pellet raw materials dried in this way may have a pellet form and may have a diameter of about 120 to 180 km.

After the spray-drying, the method may comprise granulating the pellet raw materials. In other words, the pulverized and dried raw materials may be spherically formed into pellets of several millimeters (mm) in size. In the granulating the pellet raw materials, the pellet raw materials may be introduced into a rotating drum along with water and dispersed. The pellet raw materials and water may be introduced at a weight ratio in a range of 90 to 95 parts of raw materials to a range of 5 to 10 parts of water. In addition, the peripheral speed of the drum rotor may be in a range of 85 to 95 m/min. The inclination of the drum may be in a range of 50 to 65°.

According to an embodiment of the present disclosure, the granulating the pellet raw materials may further comprise firing the raw materials. The firing the raw materials may be carried out in a range of 1200 to 1350° C. In the present disclosure, the pellets may be completely ferritized through firing the raw materials.

The MnZn ferrite pellets manufactured in this way may be the same as those described above. In other words, the MnZn ferrite pellets may have a diameter in a range of 2 mm to 5 mm.

In addition, the MnZn ferrite pellets may have an apparent density in a range of 2.9 to 3.5 g/cc. If the apparent density of the pellets is less than 2.9 g/cc, the permeability of the manufactured magnetic material may deteriorate and higher forming pressure may be required when forming the magnetic material. If the apparent density of the pellets exceeds 3.5 g/cc, the binding force with the binder described below may decrease due to reduced specific surface area, and the appearance characteristics and strength of the manufactured magnetic material may deteriorate.

In the mixing the MnZn ferrite pellets with MnZn ferrite powder, a binder may be further included in the mixture. The binder may be the same as that described above. In other words, the binder may be a liquid silicone binder.

According to an embodiment of the present disclosure, in the mixing the MnZn ferrite pellets with MnZn ferrite powder, the MnZn ferrite pellets may be mixed in a range of 65 to 95 parts by weight, the MnZn ferrite powder in a range of 10 to 25 parts by weight, and the liquid silicone binder in a range of 2.5 to 6 parts by weight.

Hereinafter, the present disclosure is described in more detail by the following examples. However, the following examples and experimental examples are provided merely to describe the present disclosure in more detail, and the scope of the present disclosure is not limited by the following examples and experimental examples.

### Example 1

A magnetic material comprising MnZn ferrite pellets and MnZn ferrite powder was prepared.

To synthesize MnZn ferrite pellets, 70 parts by weight of iron oxide, 20 parts by weight of manganese oxide, and 10 parts by weight of zinc oxide were mixed. The mixed raw materials were calcined at about 900° C. to remove volatile impurities. Then, the calcined raw materials were wet-pulverized to produce small particles with a diameter of 1 μm or less. CaO, Nb₂O₃, Co₃O₄, ZrO₂, SnO₂, Ta₂O₅, and V₂O₅ were added to secure magnetic characteristics, and the mixed raw materials were spray-dried to produce pellets with a diameter of about 150 μm. To granulate the pellets, the manufactured pellets and water were introduced into a rotating circular drum at a weight ratio of 92:8. The peripheral speed of the drum rotor was set to a range of 85 to 95 m/min. The inclination of the drum was set to a range of 50 to 65°. The granulated pellets were heat-treated at about 1300° C. to completely ferritize them, thereby synthesizing the final MnZn ferrite pellets.

76.2 g of pellets with a diameter of 4 mm and 19.0 g of MnZn ferrite powder with a diameter of 80 μm among the thus synthesized MnZn ferrite pellets were prepared, and 4.8 g of liquid silicone binder was mixed to prepare a paste. The prepared paste was filled into a mold with dimensions of width (70 mm)×length (70 mm)×height (5 mm), and then pressed for 10 minutes at a pressure of 0.40 ton/cm² using a press preheated to 120° C. to manufacture a magnetic material.

### Example 2

A magnetic material comprising MnZn ferrite pellets and MnZn ferrite powder was prepared in the same manner as Example 1, except that MnZn ferrite pellets with a diameter of 2 mm were used.

### Example 3

A magnetic material comprising MnZn ferrite pellets and MnZn ferrite powder was prepared in the same manner as Example 1, except that MnZn ferrite pellets with a diameter of 3 mm were used.

### Comparative Example 1

An MnZn ferrite tile not comprising MnZn ferrite pellets was prepared in the same size as in Example 1.

### Comparative Example 2

A magnetic material comprising MnZn ferrite pellets and MnZn ferrite powder was prepared in the same manner as in Example 1, except that a solid binder was used.

### Experimental Example 1

In this experiment, the tap density of MnZn ferrite pellets used in Examples 1 to 3 was measured, and the permeability of magnetic materials according to Examples 1 to 3 was measured.

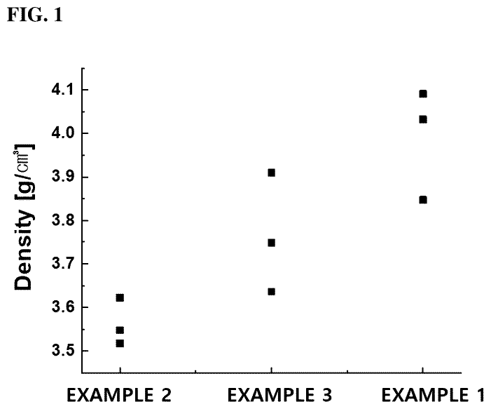

For tap density, the pellets were placed in a container, regularly tapped, and measured three times each. The results are shown in FIG. 1.

For permeability (μ), the magnetic pads of the Examples and Comparative Examples were processed into a toroid shape (outer diameter 39 mm×inner diameter 17 mm×height 5 mm), wound with 10 turns of Φ 0.5 copper wire, and inductance was measured with an LCR meter, and the permeability was calculated based on the following Formula, where L=inductance (pH), 1=mean magnetic path length (cm), N=number of turns, A=cross-sectional area (cm²).

### Formula:

$$μ = \frac{L \times l}{0.4 \times π \times {N}^{2} \times A \times 0.01}$$

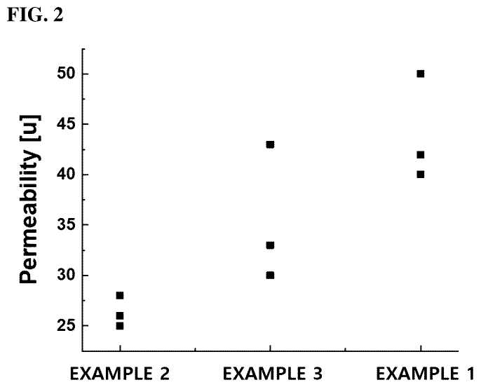

Permeability was also measured three times, and the results were converted to a ratio relative to vacuum permeability (relative permeability) and shown in FIG. 2.

Referring to FIG. 1, in Example 2, the density was measured to be about 3.5 to 3.65 g/cm³, and in Example 3, the density was measured to be about 3.65 to 3.95 g/cm³. Example 1 had a density of about 3.85 to 4.1 g/cm³. These results confirm that as the size of ferrite pellets included in the magnetic material increase, the density of the magnetic material increases.

Referring to FIG. 2, in Example 2, the relative permeability was measured to be about 25 to 28, and in Example 3, it was measured to be about 28 to 43. Example 1 exhibited a relative permeability of about 40 to 50. These results confirm that as the size of ferrite pellets increases, both density and (relative) permeability increases, thereby improving the magnetic characteristics of the magnetic material.

### Experimental Example 2

In this experiment, four samples each of the magnetic materials of Example 1, Comparative Example 1, and Comparative Example 2 were prepared and their strength was measured. For this purpose, a 300 g steel ball was dropped from a certain height onto the magnetic material, and the height at which the magnetic material was damaged as well as the impact strength (J) were measured.

The results are shown in Table 1 below.

Table 1 shows both the height at which the magnetic material was damaged and the corresponding impact strength.

TABLE 1

| | Comparative | Comparative | |
|---|---|---|---|
| | Example 1 | Example 2 | Example 1 |
| Sample | (height/strength) | (height/strength) | (height/strength) |
| 1 | 5 cm/0.147 J | 20 cm/0.588 J | 25 cm/0.735 J |
| 2 | 10 cm/0.294 J | 20 cm/0.588 J | 25 cm/0.735 J |
| 3 | 10 cm/0.294 J | 20 cm/0.588 J | 30 cm/0.882 J |
| 4 | 10 cm/0.294 J | 15 cm/0.441 J | 25 cm/0.735 J |
| Average | 0.257 J | 0.551 J | 0.771 J |

Referring to Table 1, it was confirmed that Comparative Example 1 had an average impact strength of about 0.257 J and may have a minimum impact strength of less than 0.150 J. Comparative Example 2, which used MnZn ferrite pellets and a solid binder, showed an average impact strength of 0.551 J. In contrast, Example 1 showed an average impact strength of 0.771 J and had a maximum impact strength of 0.882 J. These results confirm that when MnZn ferrite pellets are further included in existing tile-type MnZn ferrite magnetic materials, the strength of the magnetic material is improved. In addition, these results confirm that a liquid binder improves the strength of the magnetic material more than a solid binder.

The present disclosure has been particularly shown and described with reference to embodiments thereof. In this regard, it should be understood by one having ordinary skill in the art that various changes in form and details may be made therein without departing from the scope of the disclosure. Therefore, the disclosed embodiments should be considered in a descriptive sense only and not in a limiting sense. The scope of the disclosure is defined not by the detailed foregoing description but by the following claims, and all differences within the scope should be construed as being included in the disclosure.

What is claimed is:

1. A magnetic material comprising:
a range of 65 to 95 parts by weight of manganese zinc (MnZn) ferrite pellets; and
a range of 10 to 25 parts by weight of a MnZn ferrite powder.

2. The magnetic material of claim 1, wherein the MnZn ferrite pellets are spherical MnZn ferrite pellets having a diameter in a range of 2 mm to 5 mm.

3. The magnetic material of claim 1, wherein the MnZn ferrite powder has a diameter in a range of 35 μm to 90 μm.

4. The magnetic material of claim 1, wherein the MnZn ferrite powder further comprises MnZn ferrite fine particles having a diameter in a range of 4 μm to 15 μm.

5. The magnetic material of claim 4, wherein the MnZn ferrite fine particles and the MnZn ferrite powder are included in a weight ratio in a range of 0.1:9.9 to 6:4.

6. The magnetic material of claim 1, wherein the magnetic material further comprises a range of 2.5 to 6 parts by weight of a binder.

7. The magnetic material of claim 6, wherein the binder is a liquid silicone binder.

8. A wireless charging device comprising the magnetic material according to claim 1.

9. A method of manufacturing a magnetic material, the method comprising:
synthesizing manganese zinc (MnZn) ferrite pellets; and
mixing the MnZn ferrite pellets with a MnZn ferrite powder,
wherein synthesizing the MnZn ferrite pellets comprises:
mixing pellet raw materials;
calcining the mixed pellet raw materials;
pulverizing the calcined pellet raw materials; and
granulating the pulverized pellet raw materials.

10. The method of claim 9, wherein the pellet raw materials comprise iron oxide, manganese oxide, and zinc oxide.

11. The method of claim 10, wherein the pellet raw materials comprise:
a range of 65 to 75 parts by weight of iron oxide;
a range of 15 to 30 parts by weight of manganese oxide; and
a range of 5 to 15 parts by weight of zinc oxide.

12. The method of claim 9, wherein the calcining the mixed pellet raw materials is performed in a range of 800 to 1000° C.

13. The method of claim 9, wherein granulating the pulverized pellet raw materials comprises:
introducing the pulverized pellet raw materials and water into a rotating drum at a weight ratio in a range of 90 to 95 parts of the pulverized pellet raw materials to a range of 5 to 10 parts of water; and
dispersing the pulverized pellet raw materials and water in the rotating drum.

14. The method of claim 9, wherein the MnZn ferrite pellets have a diameter in a range of 2 mm to 5 mm.

15. The method of claim 9, wherein the MnZn ferrite pellets have an apparent density in a range of 2.9 to 3.5 g/cc.

16. The method of claim 9, wherein mixing the MnZn ferrite pellets with the MnZn ferrite powder further comprises mixing a liquid silicone binder.

17. The method of claim 16, wherein mixing the MnZn ferrite pellets with the MnZn ferrite powder comprises mixing:
a range of 65 to 95 parts by weight of the MnZn ferrite pellets;
a range of 10 to 25 parts by weight of the MnZn ferrite powder; and
a range of 2.5 to 6 parts by weight of the liquid silicone binder.

18. The method of claim 12, wherein an additive is added to the pulverized pellet raw materials, wherein the additive includes CaO, Nb₂O₃, Co₃O₄, ZrO₂, SnO₂, Ta₂O₅, V₂O₅, or any combination thereof.
